(19) United States
(12) Patent Application Publication
(10) Pub. No.: US 2024/0256791 A1
(43) Pub. Date: Aug. 1, 2024

(54) MACHINE LEARNING EXECUTION FRAMEWORK

(71) Applicant: Microsoft Technology Licensing, LLC, Redmond, WA (US)

(72) Inventors: Deepak SANTHANAM, Seattle, WA (US); Alexander GALKIN, Hamburg (DE); Shiroy CHOKSEY, Pleasanton, CA (US); Rittha ARAYARUNGSARIT, Mountain View, CA (US); Elbio Renato Torres ABIB, Bellevue, WA (US)

(73) Assignee: Microsoft Technology Licensing, LLC, Redmond, WA (US)

(21) Appl. No.: 18/129,571

(22) Filed: Mar. 31, 2023

Related U.S. Application Data
(60) Provisional application No. 63/442,711, filed on Feb. 1, 2023.

(51) Int. Cl. G06F 40/40; G06F 40/284

(52) U.S. Cl. CPC G06F 40/40; G06F 40/284

(57) ABSTRACT

In examples, an execution chain used to process includes one or more blocks, where each block includes at least one of a machine learning (ML) definition and/or a set of programmatic operations. As an example, an ML definition of an ML block includes a prompt to be processed by an ML model. As another example, the ML definition includes a prompt template, which may be populated based on a previous block of the execution chain. Further, a programmatic block of the execution chain can include any of a variety of operations, for example to obtain data from a data source and/or to prompt a user for input, thereby obtaining additional data that may be used to ground an ML model for a subsequent machine learning block of the execution chain.

### CROSS-REFERENCE TO RELATED APPLICATION

This application claims priority to U.S. Provisional Application No. 63/442,711, titled “Machine Learning Execution Framework,” filed on Feb. 1, 2023, the entire disclosure of which is hereby incorporated by reference in its entirety.

### BACKGROUND

Processing an input according to a single evaluation with a machine learning model may result in output having limited utility, for example due to a token limit associated with the machine learning model and/or due to limited data available to the machine learning model (e.g., due to a limited training corpus). As a result, use of the machine learning model may be restricted to only certain scenarios and/or may be limited in the input data that the model can process, among other detriments.

It is with respect to these and other general considerations that embodiments have been described. Also, although relatively specific problems have been discussed, it should be understood that the embodiments should not be limited to solving the specific problems identified in the background.

### SUMMARY

Aspects of the present disclosure relate to a machine learning execution framework. In examples, an execution chain is used to process input. The execution chain includes one or more blocks, where each block includes at least one of a machine learning definition and/or a set of programmatic operations. As an example, a machine learning definition of a machine learning block includes a prompt to be processed by a machine learning model according to aspects described herein. As another example, the machine learning definition includes a prompt template, which may be populated based on provided input data and/or a previous block of the execution chain. Further, a programmatic block of the execution chain can include any of a variety of operations, for example to obtain data from a data source and/or to prompt a user for input, to perform data pre- and/or post-processing (e.g., optical character recognition, speech recognition, and/or image generation), thereby obtaining additional data that may be used to ground an ML model for a subsequent machine learning block of the execution chain.

Thus, given the combination of programmatic processing and machine learning processing that is enabled according to the machine learning execution framework described herein, the present aspects may be used to perform any of a variety of advanced processing (e.g., compared to a singular interaction with an ML model or processing input using solely programmatic processing).

In examples, programmatic data processing allows machine learning model validation, for example by comparing the outcome of the current model against a known or an expected dataset, among other examples, thereby allowing semi-automated model tuning and/or parameter optimization.

This summary is provided to introduce a selection of concepts in a simplified form that are further described below in the Detailed Description. This summary is not intended to identify key features or essential features of the claimed subject matter, nor is it intended to be used to limit the scope of the claimed subject matter.

### BRIEF DESCRIPTION OF THE DRAWINGS

Non-limiting and non-exhaustive examples are described with reference to the following Figures.

FIG. 1 illustrates an overview of an example system in which a machine learning execution framework may be used according to aspects of the present disclosure.

FIG. 2 illustrates an overview of an example method for processing an execution chain to generate output using one or more machine learning models according to aspects described herein.

FIG. 3 illustrates an overview of an example method for processing an execution chain to validate one or more claims of a natural language input according to aspects described herein.

FIG. 4 illustrates an overview of an example user interface for a machine learning execution framework according to aspects described herein.

FIGS. 5A and 5B illustrate overviews of an example generative machine learning model that may be used according to aspects described herein.

FIG. 6 is a block diagram illustrating example physical components of a computing device with which aspects of the disclosure may be practiced.

FIG. 7 is a simplified block diagram of a computing device with which aspects of the present disclosure may be practiced.

FIG. 8 is a simplified block diagram of a distributed computing system in which aspects of the present disclosure may be practiced.

### DETAILED DESCRIPTION

In the following detailed description, references are made to the accompanying drawings that form a part hereof, and in which are shown by way of illustrations specific embodiments or examples. These aspects may be combined, other aspects may be utilized, and structural changes may be made without departing from the present disclosure. Embodiments may be practiced as methods, systems or devices. Accordingly, embodiments may take the form of a hardware implementation, an entirely software implementation, or an implementation combining software and hardware aspects. The following detailed description is therefore not to be taken in a limiting sense, and the scope of the present disclosure is defined by the appended claims and their equivalents.

In examples, a machine learning (ML) model produces model output based on an input (e.g., as may be received from a user). For example, natural language input from a user is processed using a generative ML model to produce model output for the natural language input accordingly. However, an ML model may have a token limit and/or may have a limited availability of information (e.g., due to the time range and/or breadth of data with which the model was trained), such that the output generated by the ML model has limited utility. In other examples, the ML model may fail to generate output or may generate output that is not responsive to the provided input, among other potential detriments.

Further, a part of machine learning model optimization for large language models is so-called prompt tuning, where a prompt is changed to improve model understanding and to restrict output generation according to an expected output format, thereby allowing data post-processing and analysis. For instance, a naïve formulation of a prompt might not work or may work in a limited way for a variety of tasks, such that model-specific changes to the prompt or model parameters (e.g., temperature) may be changed accordingly.

Accordingly, aspects of the present disclosure relate to a machine learning execution framework. In examples, an execution chain is used to process input. The execution chain includes one or more blocks, where each block includes at least one of a machine learning definition and/or a set of programmatic operations. The execution chain may include one or more sequential blocks, a hierarchical set of blocks, a looping set of blocks, a parallel set of blocks, and/or a block that is dependent on output generated by one or more other blocks. Thus, it will be appreciated that an execution chain may include blocks according to any of a variety of configurations, which, for example, may be represented as a directed graph.

In examples, a machine learning definition of a machine learning block includes a prompt to be processed by a machine learning model according to aspects described herein. As another example, the machine learning definition includes a prompt template, which may be populated based on a previous block of the execution chain. As an example, the prompt template is populated based on previously generated model output corresponding to a previous machine learning block. Additionally, or alternatively, the prompt template is populated based on previously generated programmatic output corresponding to a previous programmatic block. In some instances, the machine learning definition indicates a machine learning model with which the machine learning definition is to be processed. Thus, the machine learning definition describes an ML interaction corresponding to the machine learning block as part of the execution chain. It will be appreciated that processing an input according to the execution framework described herein may enable processing using multiple machine learning models (e.g., having similar or different types) to generate output for the given input.

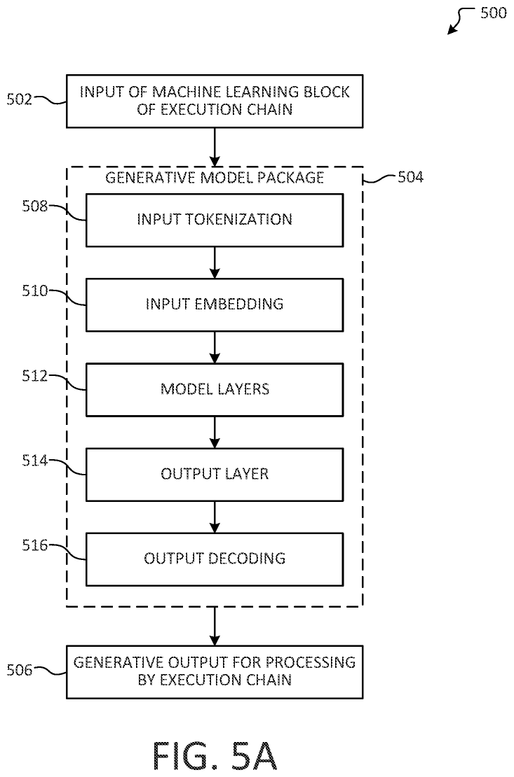

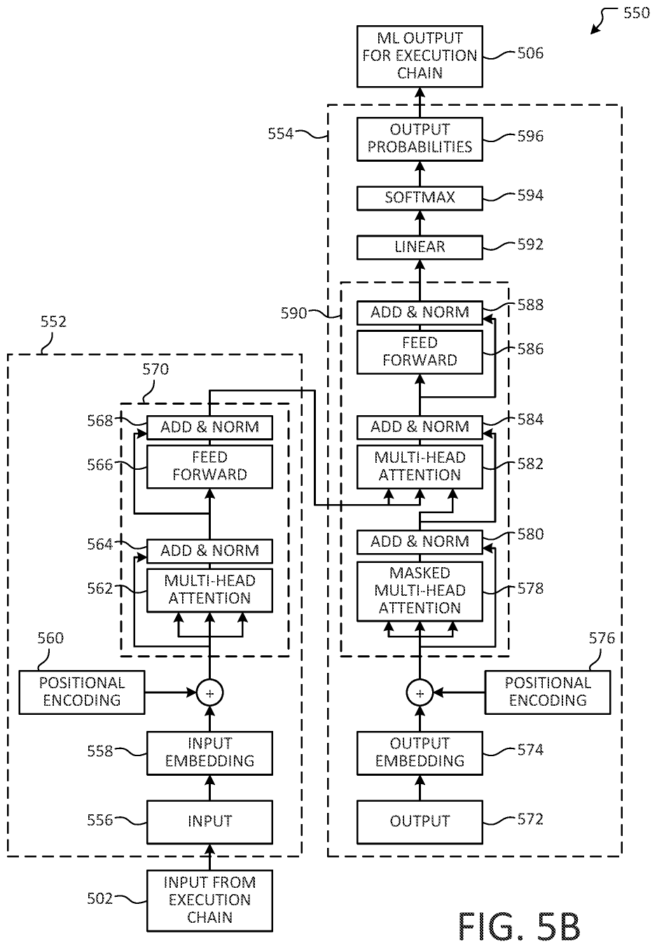

A generative model (also generally referred to herein as a type of ML model) used according to aspects described herein may generate any of a variety of output types (and may thus be a multimodal generative model, in some examples) and may be a generative transformer model and/or a large language model (LLM), a generative image model, in some examples. Example ML models include, but are not limited to, Generative Pre-trained Transformer 3 (GPT-3), BigScience BLOOM (Large Open-science Open-access Multilingual Language Model), DALL-E, DALL-E 2, Stable Diffusion, or Jukebox. Additional examples of such aspects are discussed below with respect to the generative ML model illustrated in FIGS. 5A-5B.

Example operations of a programmatic block include, but are not limited to, parsing or otherwise processing output from a previous block (e.g., to extract data from a previous programmatic and/or machine learning block), defining one or more variables, branching and/or looping logic (e.g., to affect evaluation of the execution chain according to input from one or more previous blocks and/or processing performed by the constituent block), obtaining data from a data source (e.g., a file, a database, a website, and/or a search engine), prompting a user for input (e.g., natural language input or a selection from a set of options), storing data (e.g., to a file and/or to a database), calling one or more functions and/or plugins, and/or generating output (e.g., as may be provided to a subsequent block and/or as output of the execution chain).

While examples are described herein with respect to natural language processing, it will be appreciated that any of a variety of alternative or additional content types may be processed. Other example content types include, but are not limited to, audio data, image data, video data, binary data, and/or programmatic code.

In examples, at least a part of an execution chain is created by a user, where the user defines one or more programmatic and/or machine learning blocks of the execution chain. As another example, at least a part of the execution chain is generated by a machine learning model, for example based on an evaluation of natural language indicating a task for which the execution chain is to be generated. In such an example, resulting model output is included as one or more blocks of the execution chain. Similarly the ordering and/or structure of the execution chain may be at least partially user-defined and/or ML-defined, among other examples.

In an example, an execution chain is defined for a conversational agent. In examples, the execution chain includes a machine learning block that describes a persona for the conversational agent and, in some examples, an objective. The execution chain includes a programmatic block that obtains natural language input (e.g., from a user or from another conversational agent, as may be defined by another, similar execution chain). A machine learning definition of another machine learning block of the execution chain is populated by the programmatic block, thereby generating a prompt with which model output is generated that is responsive to the received input. In examples, the machine learning definition is further populated with an indication of the persona and the objective defined by the machine learning block noted above. The machine learning definition may further include at least a part of the conversation, thereby providing context with which to generate the model output. In some instances, the programmatic block obtains additional data (e.g., relating to the input), which is further incorporated into the prompt. The additional data may introduce additional grounding for processing by the ML model, for example to account for new information that has become available after the ML model was trained.

A subsequent programmatic block of the execution chain processes the resulting model output, for example to select or otherwise extract a portion of the model output to provide in response to the received input. The execution chain may thus loop between the programmatic and machine learning blocks of the execution chain, thereby operating as the conversational agent to process input according to the defined persona/objective. In examples, execution loops until it is determined that the objective has been satisfied (e.g., as may be determined based on programmatic and/or ML-based evaluation of the conversation history).

As another example, an execution chain defines a set of blocks with which to classify input data. Similar to the example execution chain for a conversational agent, an execution chain for classification may obtain input data, populate a prompt template with at least a part of the input data and context (e.g., as may be obtained by a programmatic block), and perform processing associated with a machine learning block to generate model output that classifies the input accordingly (e.g., based on the context). As a result, a programmatic block may process the model output to store at least a part of the model output in association with the input, thereby annotating the input data with the classification accordingly. The annotated training data may thus be used to subsequently train a machine learning model, among any of a variety of additional or alternative uses. Thus, in contrast to or in addition to manual data annotation, the described machine learning execution framework enables the creation of an execution chain with which to annotate input data accordingly.

Similarly, an execution chain may be used to form a more complex classifier than may otherwise be possible through a singular machine learning interaction. For example, a programmatic block of the execution chain generates a set of subparts for a given input. The execution chain iteratively processes each subpart of the set of subparts to classify the subpart accordingly. Finally, the execution chain aggregates classifications for each of the subparts (e.g., via one or more machine learning blocks and/or programmatic blocks), thereby generating an overall classification for the input. As a result of segmenting the input into multiple subparts, better attention may be paid to the semantic meaning and/or other features of the subparts, thereby enabling an improved classification as compared to a singular machine learning interaction. Additionally, or alternatively, it may be possible to process an input that would otherwise exceed a token limit for the machine learning model. As a further example, different ML, models may be used to process different subparts of the input, thereby enabling classification of multiple content types for the input that may otherwise not have been possible.

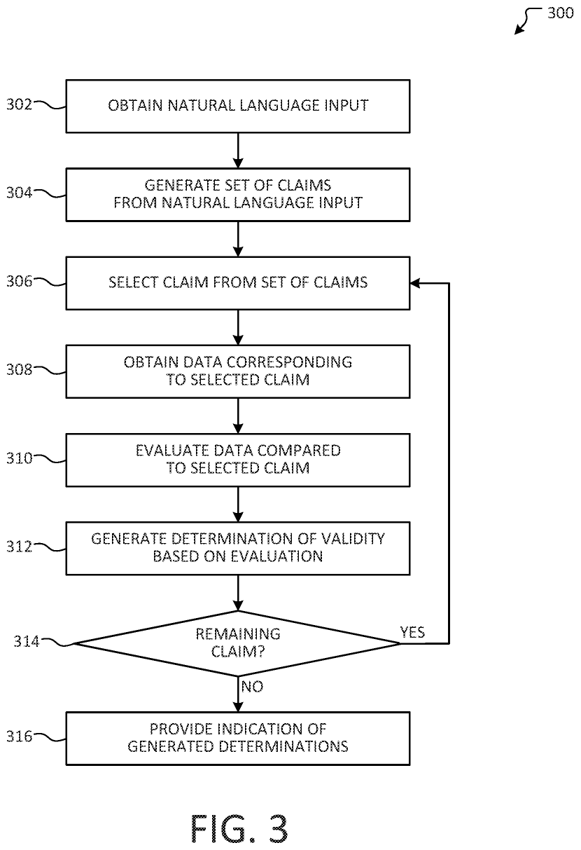

Given the combination of programmatic processing and machine learning processing that is enabled according to the machine learning execution framework described herein, the present aspects may be used to perform any of a variety of advanced processing (e.g., compared to a singular interaction with an ML model or processing input using solely programmatic processing). Several examples of such processing are described herein, though it will be appreciated that the disclosed aspects may be used for any of a variety of other processing according to an execution chain. In examples, the disclosed aspects may be used to evaluate model output to identify an instance of hallucination (e.g., where the model output includes a claim that is not factual), additional aspects of which are described below with respect to method 300 in FIG. 3.

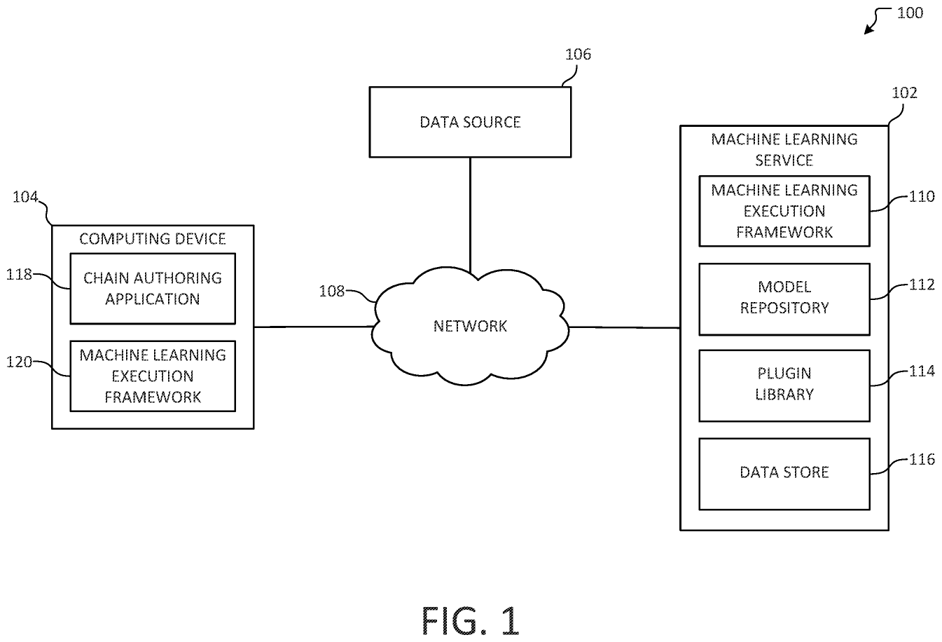

FIG. 1 illustrates an overview of an example system 100 in which a machine learning execution framework may be used according to aspects of the present disclosure. As illustrated, system 100 includes machine learning service 102, computing device 104, data source 106, and network 108. In examples, machine learning service 102, computing device 104, and/or data source 106 communicate via network 108, which may comprise a local area network, a wireless network, or the Internet, or any combination thereof, among other examples.

As illustrated, machine learning service 102 includes machine learning execution framework 110, model repository 112, plugin library 114, and data store 116. In examples, machine learning service 102 receives an indication of an execution chain from computing device 104, as may have been authored by a user via chain authoring application 118. As another example, at least a part of the execution chain is processed by computing device 104 (e.g., by machine learning execution framework 120). In some instances, machine learning execution framework 110 of machine learning service 102 additionally or alternatively processes at least a part of the execution chain.

Thus, aspects of machine learning execution framework 120 may be similar to machine learning execution framework 110 and are therefore not necessarily redescribed below in detail. Further, while system 100 is illustrated as an example in which chain authoring is performed at computing device 104 and machine learning processing is performed at machine learning service 102 (e.g., using one or more models of model repository 112), it will be appreciated that, in other examples, the disclosed aspects may be distributed among a variety of computing devices according to any of a variety of paradigms. For example, machine learning execution framework 120 may perform programmatic processing of an execution chain, while at least a part of the machine learning processing of the execution chain is performed by machine learning service 102.

Machine learning execution framework 110 processes an execution chain according to aspects described herein. As noted above, at least a part of the execution chain may have been created by a user (e.g., of computing device 104, using chain authoring application 118) and/or at least a part of the execution chain may have been generated by a machine learning model (e.g., of model repository 112), among other examples.

As noted above, the execution chain includes programmatic and/or machine learning blocks. For example, when processing a machine learning block, machine learning execution framework 110 may identify a prompt or populate a prompt template of the machine learning block, which is provided for processing by a model of model repository 112. In examples, the machine learning block includes an indication of a machine learning model of model repository 112 with which the machine learning block is to be processed.

Model repository 112 may include any number of different ML models. For example, model repository 112 may include foundation models, language models, speech models, video models, and/or audio models. As used herein, a foundation model is a model that is pre-trained on broad data that can be adapted to a wide range of tasks (e.g., models capable of processing various different tasks or modalities). In examples, a multimodal machine learning model of model repository 112 may have been trained using training data having a plurality of content types. Thus, given content of a first type, an ML model of model repository 112 may generate content having any of a variety of associated types. It will be appreciated that model repository 112 may include a foundation model as well as a model that has been finetuned (e.g., for a specific context and/or a specific user or set of users), among other examples.

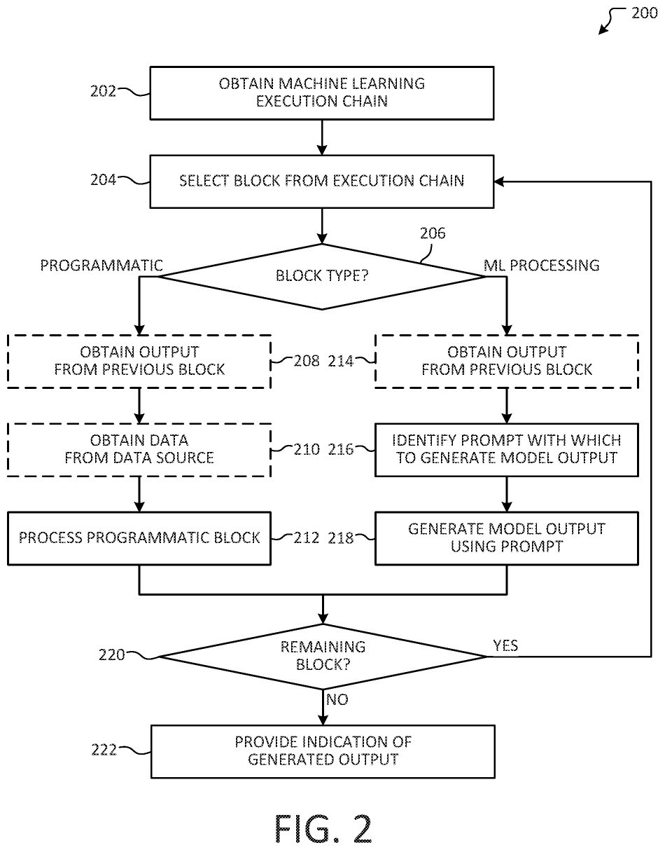

As another example, machine learning execution framework 110 processes programmatic code of a programmatic block. For instance, the programmatic block references a plugin of plugin library 114, for example to extract data from output of a previous block, to obtain data from a data source (e.g., data source 106), and/or to store data (e.g., in a file or in data store 116). It will be appreciated that the programmatic code may include any of a variety of additional or alternative operations in other examples. The programmatic code may be an interpreted language and/or a compiled language, among other examples. For instance, a user may author the programmatic code section using Python or C#, which may include looping and/or branching logic to control execution of the execution chain according to aspects described herein. Additional aspects of execution chain processing are described below with respect to method 200 of FIG. 2.

System 100 is further illustrated as including data source 106, which may be a database, a search engine, a message board, a social media website, and/or an online encyclopedia, among other examples. In examples, data from data source 106 is obtained as part of processing an execution chain, for example to provide additional grounding for machine learning processing (e.g., associated with a machine learning block of an execution chain, as may be processed by a model of model repository 112). As another example, the data is used for validating one or more claims, for example of input and/or as was generated as part of an execution chain. Examples of such aspects are described below with respect to method 300 of FIG. 3.

It will be appreciated that data source 106 is provided as an example and, in other examples, any of a variety of additional or alternative data sources may be used. For example, computing device 104 may include a data source (e.g., including user-specific data) and/or machine learning service 102 may include a data source. As another example, processing an execution chain according to aspects described herein may cause a user (e.g., of computing device 104) to be prompted for data.

With reference now to computing device 104, computing device 104 further includes chain authoring application 118. In examples, chain authoring application 118 is used to create, modify, and/or otherwise manage one or more execution chains. For example, a user defines various blocks and corresponding structure of the execution chain. The user may provide an indication to execute the execution chain, at which point machine learning execution framework 120 and/or machine learning execution framework 110 process the execution chain according to aspects described herein.

Chain authoring application 118 may be used to evaluate the performance of an execution chain, for example based on previous executions of the execution chain and/or based on multiple instances of processing the execution chain. Such multiple instances may be performed based on different inputs (e.g., different personas/objectives, in the context of the conversational agent example). In examples, resulting output is scored (e.g., as successful or unsuccessful, as having obtained accurate information, and/or the degree to which an objective was achieved). Thus, chain authoring application 118 may present an indication to a user as to how changes to an execution chain (e.g., to programmatic code and/or to one or more machine learning definitions) have affected chain performance over time. For instance, a user may refine a prompt template or other aspects of a machine learning definition based on the performance of the execution chain accordingly, thereby supporting the ability of the user to engage in prompt engineering and thus build comparatively higher-quality prompts. In examples, chain authoring application 118 also enables a user to view intermediate output that is generated during execution chain processing (e.g., as may be stored in data store 116) and/or to view inputs/outputs to various blocks of the execution chain for a given instance of execution chain processing.

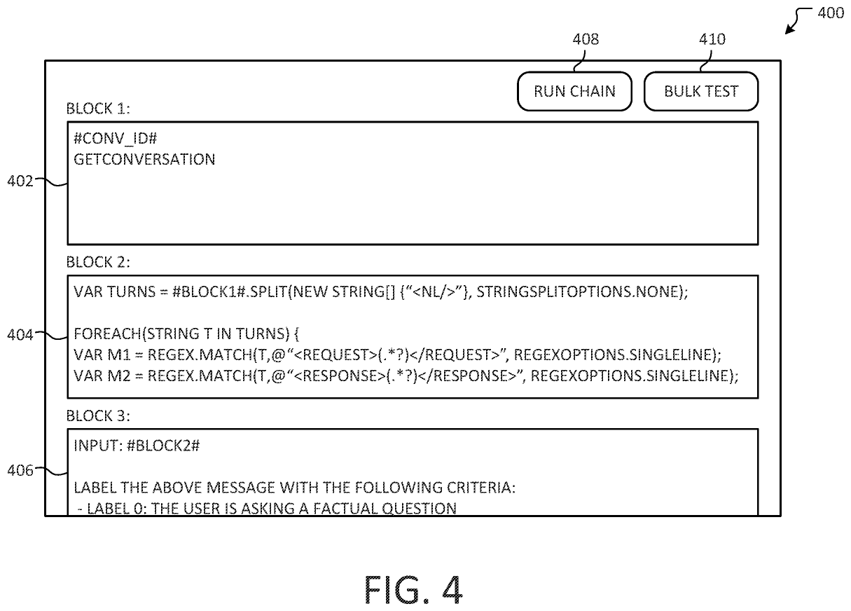

It will therefore be appreciated that chain authoring application 118 may provide any of a variety of authoring, debugging, analytics, and/or execution capabilities. An example authoring interface for chain authoring application 118 is discussed below with respect to FIG. 4.

FIG. 2 illustrates an overview of an example method 200 for processing an execution chain to generate output using one or more machine learning models according to aspects described herein. In examples, aspects of method 200 are performed by a machine learning execution framework (e.g., machine learning execution framework 110 and/or 120 in FIG. 1), among other examples.

As illustrated, method 200 begins at operation 202, where a machine learning execution chain is obtained. For example, the machine learning execution chain may be obtained from a chain authoring application, such as chain authoring application 118 discussed above with respect to FIG. 1. As another example, at least a part of the execution chain may be programmatically generated and/or generated by a machine learning model, among other examples.

At operation 204, a block is selected from the execution chain. As noted above, an execution chain may be structured according to any of a variety of paradigms. In instances where operation 204 is initially performed, the selected block may be the block at which execution of the execution chain begins (e.g., a root block).

Accordingly, at determination 206, a type of the block is determined. In examples, the block includes an indication of a corresponding type. In other examples, the type is determined based on the content of the block. For example, if text that defines the block is determined to include programmatic code, it is determined that the block is a programmatic block. Similarly, if text that defines the block includes one or more characters that indicate the block is a machine learning block, it may thus be determined the block is a machine learning block. It will be appreciated that any of a variety of additional or alternative techniques may be used to determine a type of the selected block.

If the block is a programmatic block, flow branches “PROGRAMMATIC” to operation 208, where output from a previous block is obtained. Operation 208 is illustrated using a dashed box to indicate that, in some examples, operation 208 is omitted. For example, operation 208 may be omitted in instances where a previous iteration of the illustrated method has not yet been performed. Operation 208 may include obtaining output from any of a variety of previous blocks, for example as may be referenced based on a corresponding identifier. In other examples, operation 208 additionally or alternatively comprises obtaining data from one or more variables of a previous block.

Flow progresses to operation 210. Operation 210 is illustrated using a dashed box to indicate that, in some examples, operation 210 is omitted. Operation 210 is included as an example operation that may be performed as part of execution programmatic code of a programmatic block. For example, operation 210 may comprise obtaining data from a data source (e.g., data source 106 in FIG. 1). In examples, operation 210 obtains information based at least in part on output of a machine learning block, as may be the case when the machine learning block is used to generate a search query with which data is retrieved at operation 210.

At operation 212, the programmatic block is processed. For example, operation 212 comprises parsing or otherwise executing programmatic code of the programmatic block (e.g., based on output from a previous block and/or data that was obtained from a data source). Programmatic processing performed at operation 212 may generate output of the block, store data in a data store (e.g., for subsequent retrieval by one or more subsequent blocks), and/or create, update, or delete one or more variables, among other examples. In some instances, processing at operation 212 affects execution of the execution chain, for example causing execution to branch or loop, among other examples. Flow then progresses to determination 220, which is discussed below.

Returning to determination 206, if it is instead determined that the block type is a machine learning processing block, flow branches “ML PROCESSING” to operation 214, where output is obtained from a previous block. Aspects of operation 214 may be similar to those discussed above with respect to operation 208 and are therefore not necessarily redescribed in detail. Similar to operation 208, operation 214 is illustrated using a dashed box to indicate that, in some examples, operation 214 may be omitted.

Method 200 progresses to operation 216, where a prompt with which to generate model output is identified. As noted above, the machine learning block includes a machine learning definition, which includes a prompt or, in other examples, a prompt template. In instances where the machine learning block includes a prompt template, the prompt template is populated at operation 216, for example to replace one or more placeholders of the prompt template with output that was obtained from one or more previous blocks (e.g., according to operation 214). Additionally, or alternatively, such output may be prepended and/or appended to a prompt template accordingly.

At operation 218, model output is generated based on the prompt from operation 216. In examples, operation 218 comprises generating a model output request, as may be the case when a computing device similar to computing device 104 performs aspects of method 200 and requests model output from machine learning service 102. As another example, operation 218 comprises identifying a machine learning model from a model repository (e.g., model repository 112 in FIG. 1), such that the machine learning model is used to process the prompt and generate model output accordingly.

At determination 220, it is determined whether there is a remaining block of the execution chain. In examples, determination 220 comprises evaluating the block that was selected at operation 204 to determine whether there are one or more subsequent blocks with which the selected block is associated. In other examples, determination 220 comprises determining whether output of the selected block indicates execution of the execution chain is to end, in which case it is determined that there is not a remaining block of the execution chain.

If it is determined there is a remaining block in the execution chain, flow branches “YES” and returns to operation 204, such that a subsequent block is selected. In examples, operation 204 comprises selecting a block based on processing that was performed at operation 212, for example to branch or loop execution of the execution chain as a result of logic that was processed in association therewith.

By contrast, if it is determined there is not a remaining block, flow branches “NO” to operation 222, where an indication of the generated output is provided. For example, operation 222 comprises providing the indication of output in response to input that was received from the user, such that the output is displayed to the user. As another example, the output is provided for subsequent processing (e.g., by an application of a computing device), among other examples. Method 200 terminates at operation 222.

FIG. 3 illustrates an overview of an example method 300 for processing an execution chain to validate one or more claims of a natural language input according to aspects described herein. In examples, aspects of method 300 are performed by a machine learning execution framework (e.g., machine learning execution framework 110 and/or 120 in FIG. 1), among other examples. Thus, the operations illustrated by method 300 may form at least a part of an execution chain according to aspects described herein, as may be processed as a result of performing aspects similar to method 200 of FIG. 2.

As illustrated, method 300 begins at operation 302, where natural language input is obtained. In examples, the natural language input includes model output, as may be generated in association with a machine learning block according to aspects described herein. In other examples, at least a part of the natural language input is obtained from a user, among any of a variety of alternative or additional sources.

At operation 304, a set of claims are generated from the natural language input. For example, operation 304 is performed in association with a machine learning block that includes a prompt template that requests that a machine learning model extract or otherwise generate a list of claims that are recited by the obtained natural language input. Accordingly, operation 304 comprises populating the prompt template and providing the populated prompt template from ML processing, thereby generating output that includes the set of claims. It will be appreciated that any of a variety of alternative or additional claim extraction techniques may be used in other examples.

Flow progresses to operation 306, where a claim is selected from the generated set of claims. In examples, aspects of operation 306 are performed by programmatic code of a programmatic block, for example by iterating through the extracted claims accordingly.

At operation 308, data corresponding to the selected claim is obtained for example, a machine learning block may include a prompt template that is populated according to the selected claim, which includes a prompt to induce the ML model to generate a search query with which information corresponding to the claim may be identified. Accordingly, a programmatic block provides the search query generated by the ML model to a search engine, thereby obtaining one or more results corresponding to the claim. For example, the programmatic block extracts a title, content, and/or any of a variety of additional or alternative information from the search engine. It will be appreciated that data may be obtained from any of a variety of additional or alternative data sources in other examples (e.g., data source 106 in FIG. 1).

Flow progresses to operation 310, where the data obtained at operation 308 is compared to the claim that was selected at operation 306. In examples, operation 306 comprises processing a machine learning block that includes a prompt template in which the data and the claim are populated. For example, the prompt includes a prompt to induce the ML model to evaluate whether the claim is supported by the data. In some examples, the prompt requests that the ML model provide an indication as to the degree to which the claim is supported by the data. Thus, as a result of the aspects described herein, the model is provided with additional data with which to ground itself when evaluating the claim.

At operation 312, a determination of validity is generated based on the evaluation. For example, operation 312 comprises extracting an evaluation result from model output that was generated at operation 312 (e.g., by a programmatic block of the execution chain). The validity determination may be associated with the claim, such that an indication of the claim's validity is provided at operation 316 accordingly.

Flow progresses to operation 316, where it is determined whether there is a remaining claim (e.g., by a programmatic block of the execution chain). If it is determined there is a remaining claim, flow returns to operation 306, such that method 300 loops between operations 306-314 to process the claims that were extracted at operation 304.

By contrast, if it is determined there is not a remaining claim, flow branches “NO” to operation 316, where an indication of the generated validity determinations is provided. In examples, operation 316 includes aggregating the validity determinations that were generated by one or more iterations of operation 312, as may be performed by a programmatic and/or machine learning block. The indication of the generated determinations may be provided for user review and/or for subsequent processing according to an execution chain.

In an example, a claim that is determined to be factually incorrect may be revised as a result of an execution chain according to aspects described herein, where corresponding data (e.g., as was obtained at operation 308) may be used to update the claim accordingly (e.g., by a programmatic and/or machine learning block). Such aspects may be performed as a result of operation 316 or, as another example, a method similar to method 300 may revise the claim in addition to or as an alternative to generating the determination of validity corresponding to the claim. As illustrated, method 300 terminates at operation 316.

FIG. 4 illustrates an overview of an example user interface 400 for a machine learning execution framework (e.g., as may be implemented by a chain authoring application, such as chain authoring application 118 in FIG. 1) according to aspects described herein. As illustrated, user interface 400 includes blocks 402, 404, and 406. A user may provide an indication to add blocks, remove blocks, and/or rearrange blocks, among other examples. As illustrated, block 402 and block 404 are programmatic blocks, where block 402 calls the “GETCONVERSATION” plugin (e.g., as may be stored in plugin library 114) to obtain requests/responses corresponding to a conversation ID (e.g., from a data store, such as data store 116), while block 404 includes programmatic code to extract requests/responses from the output of block 404 (e.g., “#BLOCK1#”) accordingly.

Block 406 illustrates an example machine learning block, where a corresponding machine learning definition may be authored by the user. As illustrated, block 406 includes a prompt template, where an output for block 404 is populated as input for the prompt template (e.g., as may be populated at the recitation of “#BLOCK2” accordingly).

User interface 400 further comprises “RUN CHAIN” button 408 (e.g., to run the execution chain) and “BULK TEST” button 410 (e.g., to test performance of the execution chain according to multiple iterations). Thus, a user may revise aspects of the execution chain defined by blocks 402, 404, 406, may add additional blocks, may remove blocks, and/or may change the structure of blocks of the execution chain according to aspects described herein. It will be appreciated that blocks 402, 404, and 406 are provided as example blocks and, in other examples, different blocks may be used according to any of a variety of different structures.

FIGS. 5A and 5B illustrate overviews of an example generative machine learning model that may be used according to aspects described herein. With reference first to FIG. 5A, conceptual diagram 500 depicts an overview of pre-trained generative model package 504 that processes an input 502 of a machine learning block of an execution chain to generate model output 506 for processing by an execution chain according to aspects described herein. Examples of pre-trained generative model package 504 includes, but is not limited to, Megatron-Turing Natural Language Generation model (MT-NLG), Generative Pre-trained Transformer 3 (GPT-3), Generative Pre-trained Transformer 4 (GPT-4), BigScience BLOOM (Large Open-science Open-access Multilingual Language Model), DALL-E, DALL-E 2, Stable Diffusion, or Jukebox.

In examples, generative model package 504 is pre-trained according to a variety of inputs (e.g., a variety of human languages, a variety of programming languages, and/or a variety of content types) and therefore need not be finetuned or trained for a specific scenario. Rather, generative model package 504 may be more generally pre-trained, such that input 502 includes a prompt that is generated, selected, or otherwise engineered to induce generative model package 504 to produce certain generative model output 506. For example, a prompt includes a context and/or one or more completion prefixes that thus preload generative model package 504 accordingly. As a result, generative model package 504 is induced to generate output based on the prompt that includes a predicted sequence of tokens (e.g., up to a token limit of generative model package 504) relating to the prompt. In examples, the predicted sequence of tokens is further processed (e.g., by output decoding 516) to yield output 506. For instance, each token is processed to identify a corresponding word, word fragment, or other content that forms at least a part of output 506. It will be appreciated that input 502 and generative model output 506 may each include any of a variety of content types, including, but not limited to, text output, image output, audio output, video output, programmatic output, and/or binary output, among other examples. In examples, input 502 and generative model output 506 may have different content types, as may be the case when generative model package 504 includes a generative multimodal machine learning model.

As such, generative model package 504 may be used in any of a variety of scenarios and, further, a different generative model package may be used in place of generative model package 504 without substantially modifying other associated aspects (e.g., similar to those described herein with respect to FIGS. 1, 2, 3, and 4). Accordingly, generative model package 504 operates as a tool with which machine learning processing is performed, in which certain inputs 502 to generative model package 504 are programmatically generated or otherwise determined, thereby causing generative model package 504 to produce model output 506 that may subsequently be used for further processing.

Generative model package 504 may be provided or otherwise used according to any of a variety of paradigms. For example, generative model package 504 may be used local to a computing device (e.g., computing device 104 in FIG. 1) or may be accessed remotely from a machine learning service (e.g., machine learning service 102). In other examples, aspects of generative model package 504 are distributed across multiple computing devices. In some instances, generative model package 504 is accessible via an application programming interface (API), as may be provided by an operating system of the computing device and/or by the machine learning service, among other examples.

With reference now to the illustrated aspects of generative model package 504, generative model package 504 includes input tokenization 508, input embedding 510, model layers 512, output layer 514, and output decoding 516. In examples, input tokenization 508 processes input 502 to generate input embedding 510, which includes a sequence of symbol representations that corresponds to input 502. Accordingly, input embedding 510 is processed by model layers 512, output layer 514, and output decoding 516 to produce model output 506. An example architecture corresponding to generative model package 504 is depicted in FIG. 5B, which is discussed below in further detail. Even so, it will be appreciated that the architectures that are illustrated and described herein are not to be taken in a limiting sense and, in other examples, any of a variety of other architectures may be used.

FIG. 5B is a conceptual diagram that depicts an example architecture 550 of a pre-trained generative machine learning model that may be used according to aspects described herein. As noted above, any of a variety of alternative architectures and corresponding ML models may be used in other examples without departing from the aspects described herein.

As illustrated, architecture 550 processes input 502 to produce generative model output 506, aspects of which were discussed above with respect to FIG. 5A. Architecture 550 is depicted as a transformer model that includes encoder 552 and decoder 554. Encoder 552 processes input embedding 558 (aspects of which may be similar to input embedding 510 in FIG. 5A), which includes a sequence of symbol representations that corresponds to input 556. In examples, input 556 includes input 502 corresponding to a machine learning block of an execution chain.

Further, positional encoding 560 may introduce information about the relative and/or absolute position for tokens of input embedding 558. Similarly, output embedding 574 includes a sequence of symbol representations that correspond to output 572, while positional encoding 576 may similarly introduce information about the relative and/or absolute position for tokens of output embedding 574.

As illustrated, encoder 552 includes example layer 570. It will be appreciated that any number of such layers may be used, and that the depicted architecture is simplified for illustrative purposes. Example layer 570 includes two sub-layers: multi-head attention layer 562 and feed forward layer 566. In examples, a residual connection is included around each layer 562, 566, after which normalization layers 564 and 568, respectively, are included.

Decoder 554 includes example layer 590. Similar to encoder 552, any number of such layers may be used in other examples, and the depicted architecture of decoder 554 is simplified for illustrative purposes. As illustrated, example layer 590 includes three sub-layers: masked multi-head attention layer 578, multi-head attention layer 582, and feed forward layer 586. Aspects of multi-head attention layer 582 and feed forward layer 586 may be similar to those discussed above with respect to multi-head attention layer 562 and feed forward layer 566, respectively. Additionally, masked multi-head attention layer 578 performs multi-head attention over the output of encoder 552 (e.g., output 572). In examples, masked multi-head attention layer 578 prevents positions from attending to subsequent positions. Such masking, combined with offsetting the embeddings (e.g., by one position, as illustrated by multi-head attention layer 582), may ensure that a prediction for a given position depends on known output for one or more positions that are less than the given position. As illustrated, residual connections are also included around layers 578, 582, and 586, after which normalization layers 580, 584, and 588, respectively, are included.

Multi-head attention layers 562, 578, and 582 may each linearly project queries, keys, and values using a set of linear projections to a corresponding dimension. Each linear projection may be processed using an attention function (e.g., dot-product or additive attention), thereby yielding n-dimensional output values for each linear projection. The resulting values may be concatenated and once again projected, such that the values are subsequently processed as illustrated in FIG. 5B (e.g., by a corresponding normalization layer 564, 580, or 584).

Feed forward layers 566 and 586 may each be a fully connected feed-forward network, which applies to each position. In examples, feed forward layers 566 and 586 each include a plurality of linear transformations with a rectified linear unit activation in between. In examples, each linear transformation is the same across different positions, while different parameters may be used as compared to other linear transformations of the feed-forward network.

Additionally, aspects of linear transformation 592 may be similar to the linear transformations discussed above with respect to multi-head attention layers 562, 578, and 582, as well as feed forward layers 566 and 586. Softmax 594 may further convert the output of linear transformation 592 to predicted next-token probabilities, as indicated by output probabilities 596. It will be appreciated that the illustrated architecture is provided in as an example and, in other examples, any of a variety of other model architectures may be used in accordance with the disclosed aspects. In some instances, multiple iterations of processing are performed according to the above-described aspects (e.g., using generative model package 504 in FIG. 5A or encoder 552 and decoder 554 in FIG. 5B) to generate a series of output tokens (e.g., words), for example which are then combined to yield a complete sentence (and/or any of a variety of other content). It will be appreciated that other generative models may generate multiple output tokens in a single iteration and may thus use a reduced number of iterations or a single iteration.

Accordingly, output probabilities 596 may thus form ML output 506 for processing by an execution chain according to aspects described herein, such that the output of the generative ML model may be used as output of an execution chain or for input to a subsequent block of the execution chain according to aspects described herein.

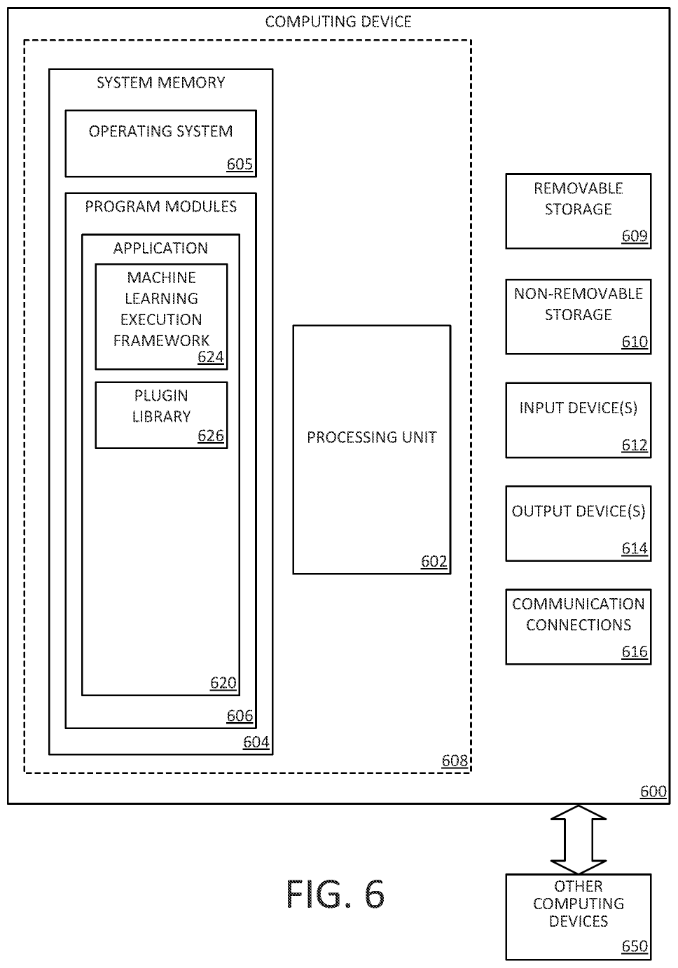

FIGS. 6-8 and the associated descriptions provide a discussion of a variety of operating environments in which aspects of the disclosure may be practiced. However, the devices and systems illustrated and discussed with respect to FIGS. 6-8 are for purposes of example and illustration and are not limiting of a vast number of computing device configurations that may be utilized for practicing aspects of the disclosure, described herein.

FIG. 6 is a block diagram illustrating physical components (e.g., hardware) of a computing device 600 with which aspects of the disclosure may be practiced. The computing device components described below may be suitable for the computing devices described above, including one or more devices associated with machine learning service 102, as well as computing device 104 discussed above with respect to FIG. 1. In a basic configuration, the computing device 600 may include at least one processing unit 602 and a system memory 604. Depending on the configuration and type of computing device, the system memory 604 may comprise, but is not limited to, volatile storage (e.g., random access memory), non-volatile storage (e.g., read-only memory), flash memory, or any combination of such memories.

The system memory 604 may include an operating system 605 and one or more program modules 606 suitable for running software application 620, such as one or more components supported by the systems described herein. As examples, system memory 604 may store machine learning execution framework 624 and plugin library 626. The operating system 605, for example, may be suitable for controlling the operation of the computing device 600.

Furthermore, embodiments of the disclosure may be practiced in conjunction with a graphics library, other operating systems, or any other application program and is not limited to any particular application or system. This basic configuration is illustrated in FIG. 6 by those components within a dashed line 608. The computing device 600 may have additional features or functionality. For example, the computing device 600 may also include additional data storage devices (removable and/or non-removable) such as, for example, magnetic disks, optical disks, or tape. Such additional storage is illustrated in FIG. 6 by a removable storage device 609 and a non-removable storage device 610.

As stated above, a number of program modules and data files may be stored in the system memory 604. While executing on the processing unit 602, the program modules 606 (e.g., application 620) may perform processes including, but not limited to, the aspects, as described herein. Other program modules that may be used in accordance with aspects of the present disclosure may include electronic mail and contacts applications, word processing applications, spreadsheet applications, database applications, slide presentation applications, drawing or computer-aided application programs, etc.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. For example, embodiments of the disclosure may be practiced via a system-on-a-chip (SOC) where each or many of the components illustrated in FIG. 6 may be integrated onto a single integrated circuit. Such an SOC device may include one or more processing units, graphics units, communications units, system virtualization units and various application functionality all of which are integrated (or “burned”) onto the chip substrate as a single integrated circuit. When operating via an SOC, the functionality, described herein, with respect to the capability of client to switch protocols may be operated via application-specific logic integrated with other components of the computing device 600 on the single integrated circuit (chip). Embodiments of the disclosure may also be practiced using other technologies capable of performing logical operations such as, for example, AND, OR, and NOT, including but not limited to mechanical, optical, fluidic, and quantum technologies. In addition, embodiments of the disclosure may be practiced within a general purpose computer or in any other circuits or systems.

The computing device 600 may also have one or more input device(s) 612 such as a keyboard, a mouse, a pen, a sound or voice input device, a touch or swipe input device, etc. The output device(s) 614 such as a display, speakers, a printer, etc. may also be included. The aforementioned devices are examples and others may be used. The computing device 600 may include one or more communication connections 616 allowing communications with other computing devices 650. Examples of suitable communication connections 616 include, but are not limited to, radio frequency (RF) transmitter, receiver, and/or transceiver circuitry; universal serial bus (USB), parallel, and/or serial ports.

The term computer readable media as used herein may include computer storage media. Computer storage media may include volatile and nonvolatile, removable and non-removable media implemented in any method or technology for storage of information, such as computer readable instructions, data structures, or program modules. The system memory 604, the removable storage device 609, and the non-removable storage device 610 are all computer storage media examples (e.g., memory storage). Computer storage media may include RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other article of manufacture which can be used to store information and which can be accessed by the computing device 600. Any such computer storage media may be part of the computing device 600. Computer storage media does not include a carrier wave or other propagated or modulated data signal.

Communication media may be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media.

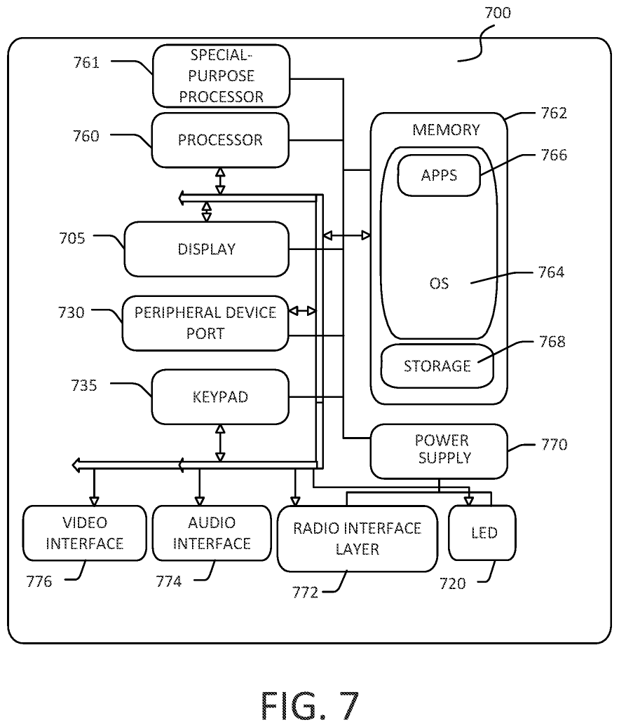

FIG. 7 illustrates a system 700 that may, for example, be a mobile computing device, such as a mobile telephone, a smart phone, wearable computer (such as a smart watch), a tablet computer, a laptop computer, and the like, with which embodiments of the disclosure may be practiced. In one embodiment, the system 700 is implemented as a “smart phone” capable of running one or more applications (e.g., browser, e-mail, calendaring, contact managers, messaging clients, games, and media clients/players). In some aspects, the system 700 is integrated as a computing device, such as an integrated personal digital assistant (PDA) and wireless phone.

In a basic configuration, such a mobile computing device is a handheld computer having both input elements and output elements. The system 700 typically includes a display 705 and one or more input buttons that allow the user to enter information into the system 700. The display 705 may also function as an input device (e.g., a touch screen display).

If included, an optional side input element allows further user input. For example, the side input element may be a rotary switch, a button, or any other type of manual input element. In alternative aspects, system 700 may incorporate more or less input elements. For example, the display 705 may not be a touch screen in some embodiments. In another example, an optional keypad 735 may also be included, which may be a physical keypad or a “soft” keypad generated on the touch screen display.

In various embodiments, the output elements include the display 705 for showing a graphical user interface (GUI), a visual indicator (e.g., a light emitting diode 720), and/or an audio transducer 725 (e.g., a speaker). In some aspects, a vibration transducer is included for providing the user with tactile feedback. In yet another aspect, input and/or output ports are included, such as an audio input (e.g., a microphone jack), an audio output (e.g., a headphone jack), and a video output (e.g., a HDMI port) for sending signals to or receiving signals from an external device.

One or more application programs 766 may be loaded into the memory 762 and run on or in association with the operating system 764. Examples of the application programs include phone dialer programs, e-mail programs, personal information management (PTM) programs, word processing programs, spreadsheet programs, Internet browser programs, messaging programs, and so forth. The system 700 also includes a non-volatile storage area 768 within the memory 762. The non-volatile storage area 768 may be used to store persistent information that should not be lost if the system 700 is powered down. The application programs 766 may use and store information in the non-volatile storage area 768, such as e-mail or other messages used by an e-mail application, and the like. A synchronization application (not shown) also resides on the system 700 and is programmed to interact with a corresponding synchronization application resident on a host computer to keep the information stored in the non-volatile storage area 768 synchronized with corresponding information stored at the host computer. As should be appreciated, other applications may be loaded into the memory 762 and run on the system 700 described herein.

The system 700 has a power supply 770, which may be implemented as one or more batteries. The power supply 770 might further include an external power source, such as an AC adapter or a powered docking cradle that supplements or recharges the batteries.

The system 700 may also include a radio interface layer 772 that performs the function of transmitting and receiving radio frequency communications. The radio interface layer 772 facilitates wireless connectivity between the system 700 and the “outside world,” via a communications carrier or service provider. Transmissions to and from the radio interface layer 772 are conducted under control of the operating system 764. In other words, communications received by the radio interface layer 772 may be disseminated to the application programs 766 via the operating system 764, and vice versa.

The visual indicator 720 may be used to provide visual notifications, and/or an audio interface 774 may be used for producing audible notifications via the audio transducer 725. In the illustrated embodiment, the visual indicator 720 is a light emitting diode (LED) and the audio transducer 725 is a speaker. These devices may be directly coupled to the power supply 770 so that when activated, they remain on for a duration dictated by the notification mechanism even though the processor 760 and other components might shut down for conserving battery power. The LED may be programmed to remain on indefinitely until the user takes action to indicate the powered-on status of the device. The audio interface 774 is used to provide audible signals to and receive audible signals from the user. For example, in addition to being coupled to the audio transducer 725, the audio interface 774 may also be coupled to a microphone to receive audible input, such as to facilitate a telephone conversation. In accordance with embodiments of the present disclosure, the microphone may also serve as an audio sensor to facilitate control of notifications, as will be described below. The system 700 may further include a video interface 776 that enables an operation of an on-board camera 730 to record still images, video stream, and the like.

It will be appreciated that system 700 may have additional features or functionality. For example, system 700 may also include additional data storage devices (removable and/or non-removable) such as, magnetic disks, optical disks, or tape. Such additional storage is illustrated in FIG. 7 by the non-volatile storage area 768.

Data/information generated or captured and stored via the system 700 may be stored locally, as described above, or the data may be stored on any number of storage media that may be accessed by the device via the radio interface layer 772 or via a wired connection between the system 700 and a separate computing device associated with the system 700, for example, a server computer in a distributed computing network, such as the Internet. As should be appreciated, such data/information may be accessed via the radio interface layer 772 or via a distributed computing network. Similarly, such data/information may be readily transferred between computing devices for storage and use according to any of a variety of data/information transfer and storage means, including electronic mail and collaborative data/information sharing systems.

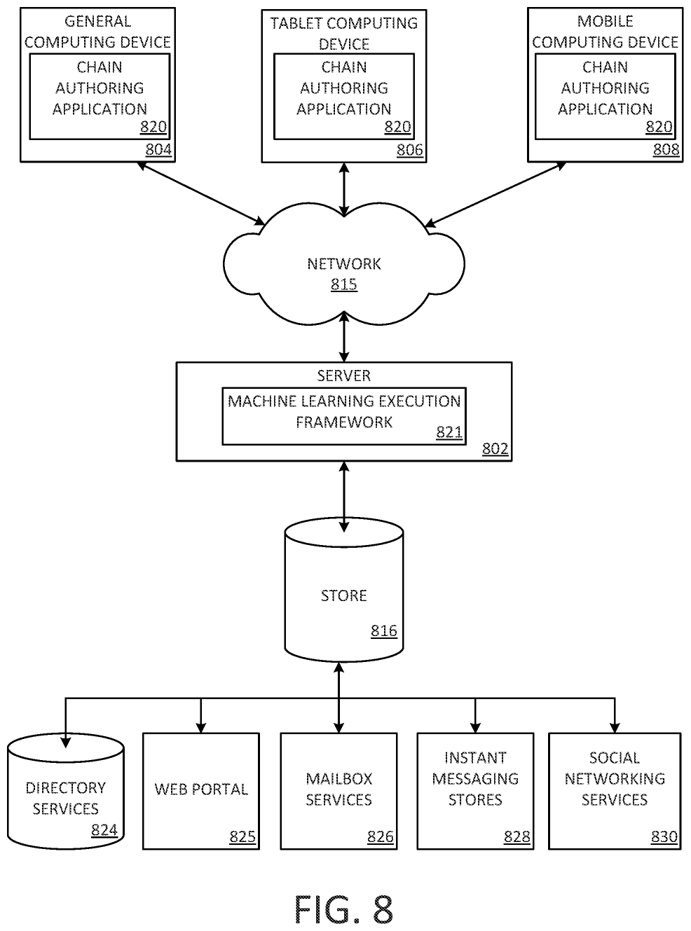

FIG. 8 illustrates one aspect of the architecture of a system for processing data received at a computing system from a remote source, such as a personal computer 804, tablet computing device 806, or mobile computing device 808, as described above. Content displayed at server device 802 may be stored in different communication channels or other storage types. For example, various documents may be stored using a directory service 824, a web portal 825, a mailbox service 826, an instant messaging store 828, or a social networking site 830.

A chain authoring application 820 (e.g., similar to application 118 in FIG. 1) may be employed by a client that communicates with server device 802. Additionally, or alternatively, machine learning execution framework 821 may be employed by server device 802. The server device 802 may provide data to and from a client computing device such as a personal computer 804, a tablet computing device 806 and/or a mobile computing device 808 (e.g., a smart phone) through a network 815. By way of example, the computer system described above may be embodied in a personal computer 804, a tablet computing device 806 and/or a mobile computing device 808 (e.g., a smart phone). Any of these examples of the computing devices may obtain content from the store 816, in addition to receiving graphical data useable to be either pre-processed at a graphic-originating system, or post-processed at a receiving computing system.

It will be appreciated that the aspects and functionalities described herein may operate over distributed systems (e.g., cloud-based computing systems), where application functionality, memory, data storage and retrieval and various processing functions may be operated remotely from each other over a distributed computing network, such as the Internet or an intranet. User interfaces and information of various types may be displayed via on-board computing device displays or via remote display units associated with one or more computing devices. For example, user interfaces and information of various types may be displayed and interacted with on a wall surface onto which user interfaces and information of various types are projected. Interaction with the multitude of computing systems with which embodiments of the invention may be practiced include, keystroke entry, touch screen entry, voice or other audio entry, gesture entry where an associated computing device is equipped with detection (e.g., camera) functionality for capturing and interpreting user gestures for controlling the functionality of the computing device, and the like.

As will be understood from the foregoing disclosure, one aspect of the technology relates to a system comprising: at least one processor; and memory storing instructions that, when executed by the at least one processor, cause the system to perform a set of operations. The set of operations comprises: obtaining input to process according to a machine learning execution chain, wherein the machine learning execution chain includes a machine learning block and a programmatic block; generating, based on the input and a prompt of the machine learning block, model output; processing, based on the programmatic block, the generated model output to generate programmatic output for the programmatic block of the machine learning execution chain; and providing an indication of output for the machine learning execution chain in response to the obtained input. In an example, the machine learning block is a first machine learning block; the model output is a first instance of model output; and the set of operations further comprises: generating, based on the programmatic output and a prompt of a second machine learning block, a second instance of model output; and providing the indication of output for the machine learning execution chain based on the second instance of model output. In another example, generating the model output comprises populating the prompt with at least a part of the obtained input, thereby generating a prompt template for processing by a machine learning model associated with the machine learning block. In a further example, generating the model output comprises: providing, to a machine learning service, an indication of the input and the prompt; and receiving, from the machine learning service, the model output for the machine learning block. In yet another example, the programmatic block includes branching logic that corresponds to one or more additional blocks of the machine learning execution chain. In a further still example, the programmatic block includes looping logic that causes the prompt of the machine learning block to be processed in a subsequent iteration of at least a part of the machine learning execution chain. In another example, the programmatic block of the machine learning execution chain includes a reference to output generated by a previous block of the machine learning execution chain other than the machine learning block.

In another aspect, the technology relates to a method. The method comprises: receiving natural language input; generating a set of claims corresponding to the natural language input; for each claim of the set of claims: obtaining additional data corresponding to the claim; evaluating the claim based on the additional data; and generating a validity determination for the claim; and providing the generated validity determinations for the set of claims in response to the received natural language input. In an example, generating the set of claims comprises: populating a prompt template with the natural language input, wherein the prompt template includes a prompt to extract claims from the natural language input; and obtaining model output for the populated prompt template that includes the set of claims. In another example, obtaining the additional data corresponding to the claim comprises: populating a prompt template with the claim, wherein the prompt template includes a prompt to generate a search query to return a set of search results associated with the claim; and obtaining model output for the populated prompt template that includes the additional data. In a further example, evaluating the claim based on the additional data comprises: populating a prompt template with the claim and the additional data, wherein the prompt template includes a prompt to compare the claim and the additional data; and obtaining model output for the populated prompt template, wherein the model output includes an indication of validity for the claim. In yet another example, generating the validity determination comprises extracting the indication of validity for the claim from the model output. In a further still example, generating the set of claims comprises processing associated with a first machine learning block of a machine learning execution chain; obtaining additional data corresponding to the claim comprises processing associated with a second machine learning block of the machine learning execution chain; and evaluating the claim based on the additional data comprises processing associated with a third machine learning block of the machine learning execution chain.

In a further aspect, the technology relates to another method. The method comprises: obtaining input to process according to a machine learning execution chain, wherein the machine learning execution chain includes a machine learning block and a programmatic block; generating, based on the input and a prompt of the machine learning block, model output; processing, based on the programmatic block, the generated model output to generate programmatic output for the programmatic block of the machine learning execution chain; and providing an indication of output for the machine learning execution chain in response to the obtained input. In an example, the machine learning block is a first machine learning block; the model output is a first instance of model output; and the method further comprises: generating, based on the programmatic output and a prompt of a second machine learning block, a second instance of model output; and providing the indication of output for the machine learning execution chain based on the second instance of model output. In another example, generating the model output comprises populating the prompt with at least a part of the obtained input, thereby generating a prompt template for processing by a machine learning model associated with the machine learning block. In a further example, generating the model output comprises: providing, to a machine learning service, an indication of the input and the prompt; and receiving, from the machine learning service, the model output for the machine learning block. In yet another example, the programmatic block includes branching logic that corresponds to one or more additional blocks of the machine learning execution chain. In a further still example, the programmatic block includes looping logic that causes the prompt of the machine learning block to be processed in a subsequent iteration of at least a part of the machine learning execution chain. In another example, the programmatic block of the machine learning execution chain includes a reference to output generated by a previous block of the machine learning execution chain other than the machine learning block.

Aspects of the present disclosure, for example, are described above with reference to block diagrams and/or operational illustrations of methods, systems, and computer program products according to aspects of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

The description and illustration of one or more aspects provided in this application are not intended to limit or restrict the scope of the disclosure as claimed in any way. The aspects, examples, and details provided in this application are considered sufficient to convey possession and enable others to make and use claimed aspects of the disclosure. The claimed disclosure should not be construed as being limited to any aspect, example, or detail provided in this application. Regardless of whether shown and described in combination or separately, the various features (both structural and methodological) are intended to be selectively included or omitted to produce an embodiment with a particular set of features. Having been provided with the description and illustration of the present application, one skilled in the art may envision variations, modifications, and alternate aspects falling within the spirit of the broader aspects of the general inventive concept embodied in this application that do not depart from the broader scope of the claimed disclosure.

What is claimed is:

1. A system comprising:
at least one processor; and
memory storing instructions that, when executed by the at least one processor, cause the system to perform a set of operations, the set of operations comprising:
obtaining input to process according to a machine learning execution chain, wherein the machine learning execution chain includes a machine learning block and a programmatic block;
generating, based on the input and a prompt of the machine learning block, model output;
processing, based on the programmatic block, the generated model output to generate programmatic output for the programmatic block of the machine learning execution chain; and
providing an indication of output for the machine learning execution chain in response to the obtained input.

2. The system of claim 1, wherein:
the machine learning block is a first machine learning block;
the model output is a first instance of model output; and
the set of operations further comprises:
generating, based on the programmatic output and a prompt of a second machine learning block, a second instance of model output; and
providing the indication of output for the machine learning execution chain based on the second instance of model output.

3. The system of claim 1, wherein generating the model output comprises populating the prompt with at least a part of the obtained input, thereby generating a prompt template for processing by a machine learning model associated with the machine learning block.

4. The system of claim 1, wherein generating the model output comprises:
providing, to a machine learning service, an indication of the input and the prompt; and
receiving, from the machine learning service, the model output for the machine learning block.

5. The system of claim 1, wherein the programmatic block includes branching logic that corresponds to one or more additional blocks of the machine learning execution chain.

6. The system of claim 1, wherein the programmatic block includes looping logic that causes the prompt of the machine learning block to be processed in a subsequent iteration of at least a part of the machine learning execution chain.

7. The system of claim 1, wherein the programmatic block of the machine learning execution chain includes a reference to output generated by a previous block of the machine learning execution chain other than the machine learning block.

8. A method, comprising:
receiving natural language input;
generating a set of claims corresponding to the natural language input;
for each claim of the set of claims:
obtaining additional data corresponding to the claim;
evaluating the claim based on the additional data; and
generating a validity determination for the claim; and
providing the generated validity determinations for the set of claims in response to the received natural language input.

9. The method of claim 8, wherein generating the set of claims comprises:
populating a prompt template with the natural language input, wherein the prompt template includes a prompt to extract claims from the natural language input; and
obtaining model output for the populated prompt template that includes the set of claims.

10. The method of claim 8, wherein obtaining the additional data corresponding to the claim comprises:
populating a prompt template with the claim, wherein the prompt template includes a prompt to generate a search query to return a set of search results associated with the claim; and
obtaining model output for the populated prompt template that includes the additional data.

11. The method of claim 8, wherein evaluating the claim based on the additional data comprises:
populating a prompt template with the claim and the additional data, wherein the prompt template includes a prompt to compare the claim and the additional data; and
obtaining model output for the populated prompt template, wherein the model output includes an indication of validity for the claim.

12. The method of claim 11, wherein generating the validity determination comprises extracting the indication of validity for the claim from the model output.

13. The method of claim 8, wherein:
generating the set of claims comprises processing associated with a first machine learning block of a machine learning execution chain;
obtaining additional data corresponding to the claim comprises processing associated with a second machine learning block of the machine learning execution chain; and
evaluating the claim based on the additional data comprises processing associated with a third machine learning block of the machine learning execution chain.

14. A method, comprising:
obtaining input to process according to a machine learning execution chain, wherein the machine learning execution chain includes a machine learning block and a programmatic block;
generating, based on the input and a prompt of the machine learning block, model output;
processing, based on the programmatic block, the generated model output to generate programmatic output for the programmatic block of the machine learning execution chain; and
providing an indication of output for the machine learning execution chain in response to the obtained input.

15. The method of claim 14, wherein:
the machine learning block is a first machine learning block;
the model output is a first instance of model output; and
the method further comprises:
generating, based on the programmatic output and a prompt of a second machine learning block, a second instance of model output; and
providing the indication of output for the machine learning execution chain based on the second instance of model output.

16. The method of claim 14, wherein generating the model output comprises populating the prompt with at least a part of the obtained input, thereby generating a prompt template for processing by a machine learning model associated with the machine learning block.

17. The method of claim 14, wherein generating the model output comprises:
providing, to a machine learning service, an indication of the input and the prompt; and
receiving, from the machine learning service, the model output for the machine learning block.

18. The method of claim 14, wherein the programmatic block includes branching logic that corresponds to one or more additional blocks of the machine learning execution chain.

19. The method of claim 14, wherein the programmatic block includes looping logic that causes the prompt of the machine learning block to be processed in a subsequent iteration of at least a part of the machine learning execution chain.

20. The method of claim 14, wherein the programmatic block of the machine learning execution chain includes a reference to output generated by a previous block of the machine learning execution chain other than the machine learning block.
